(19) United States
(12) Patent Application Publication
(10) Pub. No.: US 2004/0109646 A1
(43) Pub. Date: Jun. 10, 2004

(54) Array connector/ferrule for large core ribbon fiber

(76) Inventors: Timothy W. Anderson, Omaha, NE (US); William Andrew Gordon, Kennard, NE (US); Simon Cowley, McKinney, TX (US)

Correspondence Address: Richard C. Woodbridge, Woodbridge & Associates, P.O. Box 592, Princeton, NJ, 08542, US

(21) Appl. No.: 10/316,235

(22) Filed: Dec. 9, 2002

(51) Int. Cl. G02B 6/38

(52) U.S. Cl. 385/71

(57) ABSTRACT

A fiber optic connector contains a single thru-hole through which the cable passes essentially intact. This connector is intended to be used with a large core optic fiber ribbon cable having more than one conductor.

### FIELD OF THE INVENTION

The present invention relates to fiber optic connectors for use with large core fiber ribbon having more than one conductor.

### BACKGROUND OF THE INVENTION

Several standardized and proprietary array connectors for use with optical ribbon fiber currently exist on the market. These prior art connectors are based on the premise of precision micro-holes that accept each of the array's fibers individually. Typically, these connector systems are optimized for use with Glass Optical Fiber (GOF), which has a relatively small core diameter (9, 50 or 62 microns) when compared to diameters of Plastic Optical Fiber (POF) (typically in excess of 100 microns). These prior art connector designs are capable of maintaining the tight tolerances and precise alignments demanded by singlemode and multimode GOF when used in a connector/connector or a connector/transceiver interface. This precision however comes at a substantial cost to the manufacturer in terms of component cost/tooling/yield and assembly cost/tooling/yield.

There exist numerous suppliers of connectors, cable assemblies and associated transceivers for applications in telecommunications and data communications. By way of example, an MPO connector is a recognized industry standard developed by Nippon Telephone & Telegraph. This MPO connector employs a multi-fiber MT ferrule, which is the heart of the fiber-to-fiber and/or fiber-to-transceiver alignment at the interface. This ferrule is typically rectangular in nature with one or more rows of precision holes along its longitudinal axis into which the fibers are individually epoxied or otherwise retained—one hole per fiber. Precision alignment pins and receiving holes are typically present on the male and female connectors respectively which aid in making a precise connection.

Typically, each such MT ferrule cost in excess of $4.00. This relatively high cost is primarily due to a limited number of suppliers and the fact that the molding process is slow and low in yield. The tight tolerance requirements on hole diameter and true position mandate that the ferrule be made of thermoset material using a transfer molding process, rather than thermoplastic material. The latter material permits a much faster injection molding process. In addition, once molded, the parts are 100% inspected and sorted into different grade levels or scrapped. Further, mold maintenance is also extremely expensive due to the high cost to create, maintain and replace the small diameter core pins needed to create the small fiber holes.

The present invention is intended for relatively large core GOF or POF optical fibers. Such larger diameters of the fibers permits reduced mechanical tolerances associated with providing sufficiently accurate optical alignment for acceptable optical performance. Accordingly, the invention permits high yield, high-speed injection molding, substantially reducing tooling and mold maintenance costs due to the elimination of small diameter core pins, and minimizes the costly and time consuming inspection process.

### SUMMARY OF THE INVENTION

The present invention relates to a fiber optic connector in which the ferrule utilizes a single thru-hole or slot along its longitudinal axis designed to accept essentially all of the entire ribbon fiber construction. All optical fibers would be retained in a single hole and finished en masse using any one of several well-known methods applicable to POF. It is contemplated that this ferrule would have numerous connector applications, including but not limited to, a replacement for the industry standard multi-fiber MT ferrule in an MPO termination, a modification to industry standard RJ11/RJ45 form factor connectors and a further improved version of the RJ11/RJ45 connector employing an integral lens/cover.

### BRIEF DESCRIPTION OF THE DRAWINGS

FIG. 1 depicts various well-known examples of fiber optic ribbon cable cross-sectional structures.

FIG. 2 depicts one embodiment of the invention employed in an MPO connector.

FIG. 3 depicts an additional embodiment of the invention in which the MT ferrule contains a lens.

FIGS. 4A and 4B depict an additional embodiment of the invention used to modify an industry standard RJ11/RJ45 connector.

FIGS. 5A and 5B depict an additional embodiment of the invention wherein a RJ11/RJ45 connector is further modified to contain an integral lens/cover.

FIGS. 6A-6C depict lens optimization for various types of connections.

### DETAILED DESCRIPTION

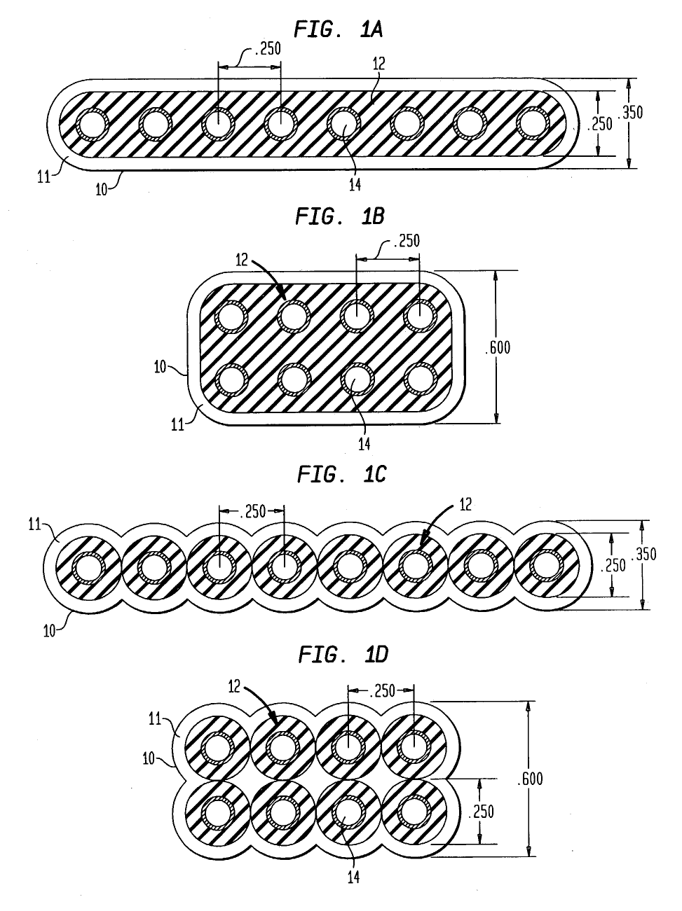

The present invention relates to an economical connector for use with large core optic fibers contained in a ribbon cable having more than one conductor. Examples of such ribbon cables are illustrated in FIG. 1. In particular, the present invention utilizes a ferrule having a single thru-hole or slot along its longitudinal axis. All fiber would be retained in this single hole and finished en masse using any one of the well-known methods applicable to POF including cleave and polish, hot knife, and hot plate finishing.

In one embodiment of the invention this thru-hole is designed to accept an entire ribbon fiber construction. Alternative embodiments envision removing some or all of the exterior covering 11 (referencing FIG. 1) of the portion of the ribbon cable which passes through the thru-hole. In all of these embodiments it is not necessary to remove all buffer material 12 that surrounds the individual optic fibers 14. Rather, this buffer material is left substantially intact to maintain the spacing of the individual optic fibers.

Because the optic fibers are fixed within a single thru-hole in this manner, thereby eliminating the need to remove the buffer material 12 from the fiber ribbon 10 the invention reduces termination process time, reduces tooling costs, eliminates the potential for crossed or mis-oriented fibers, and eliminates the potential for damage to the fiber 14 as a result of the buffer removal process. Accordingly, the invention substantially reduces the cost associated with molding the ferrule and terminating the connector on a fiber ribbon.

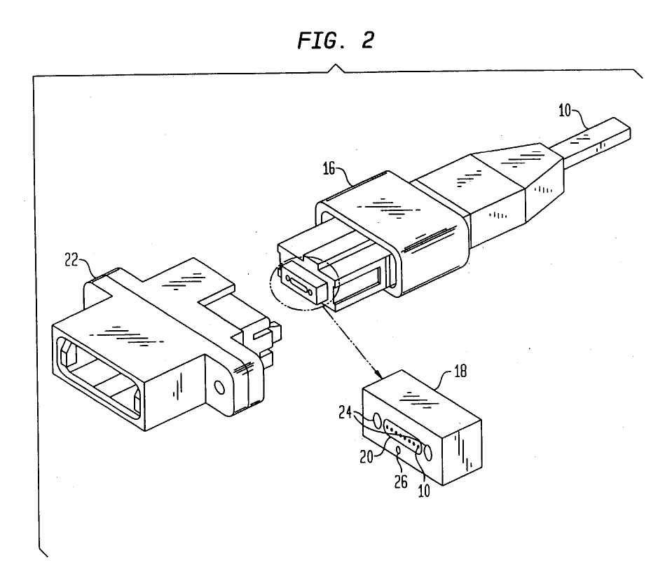

FIG. 2 depicts an embodiment of the invention which is contemplated to be a replacement for the industry standard multi-fiber MT ferrule in an MPO termination. In this embodiment an MPO connector 16 is designed to interface with another connector or a transceiver. As illustrated in FIG. 2, the connector 16 comprises a ferrule 18 which has a single slot 20 through which the fiber ribbon 10 passes. Alignment holes 24 are illustrated which align with corresponding alignment pins (not illustrated) on a mating connector through the use of an adapter 22 to effect a precise alignment of the connected parts. Similarly, integral alignment pins are employed with the associated transceiver (not illustrated) to effectively couple light to/from the optical fiber.

This embodiment of the invention is applicable to multiple variations of ribbon fiber construction having fiber array configurations of N rows by M columns where the mathematical product N×M>1. Examples of such ribbon fibers are illustrated in FIG. 1. By maintaining the standard 250 micron fiber pitch on the ribbon, this connector could be compatible with existing transceiver mechanical designs. However, the invention is not so limited as fiber pitches of both greater than and less than 250 microns are contemplated by the invention.

In an additional embodiment of the invention, one or more keying mechanisms would be employed to avoid mismatching, for example, a POF MPO into a transceiver intended for GOF (and vice versa). FIG. 2 depicts an example of such a keying mechanism 26 which is simply a diamond shaped male pin which mates with a corresponding female hole (not illustrated) on the transceiver or the adapter 22.

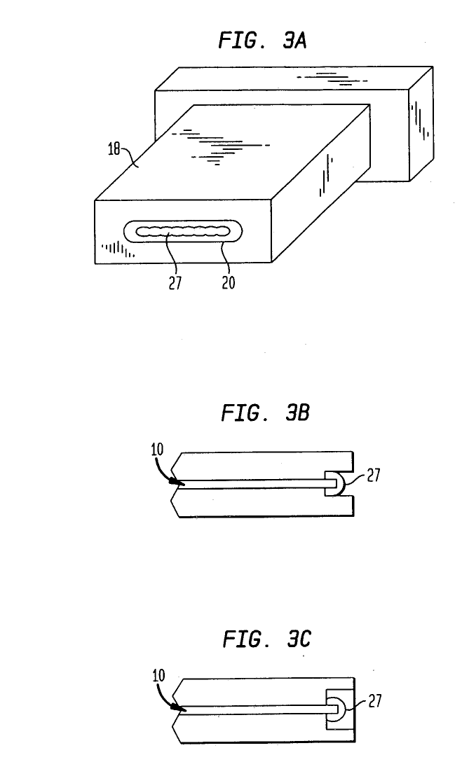

FIGS. 3A-C depicts an additional embodiment of the invention wherein the MT ferrule 18 comprises a lens 27 at the connection end of the slot 20. Such a lens can be molded from an optically transparent material and integral formed with the ferrule FIG. 3B or attached to the ferrule as a separate component 3C. In either embodiment, the slot or thru-hole 20 would guide the pre-cut fiber ribbon 10 to the rear of the lens 27. Index matching gel, optical epoxy, or other adherent could be utilized in these embodiments.

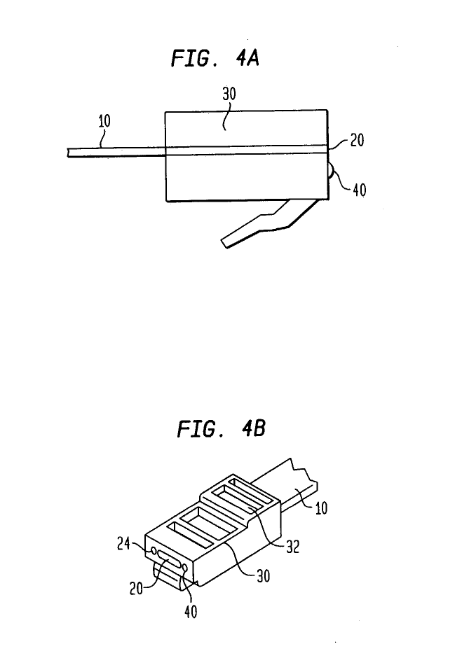

FIGS. 4A and 4B depict an embodiment of the invention which is a modification to the industry standard RJ11/RJ45 form factor connector. As in the previously described embodiments, the connector 30 comprises a single slot 20 through which the fiber ribbon 10 passes completely or essentially intact. This slot is molded directly into the body of the connector, or alternatively, into a secondary piece within an outer shell. A fiber ribbon retention mechanism 32, as is well-known in the industry and integral ferrule alignment posts 40 are also illustrated. This embodiment provides an ultra low cost connector with single piece molded housing construction. By creating the alignment features on the same molded component as the fiber slot, manufacturing tolerance variation can be minimized. Further, by utilizing a hermaphroditic design (indentation on one side, post on the other) a single molding could be used for both sides of a connector-to-connector interface. Additional well-known components for a greater degree of ruggedization and/or optical alignment could be added.

This embodiment provides a fiber ribbon termination which greatly reduces the complexities associated with a standard MPO connector assembly. The single piece housing comprises all the functions of optical fiber alignment, fiber ribbon/cable retention, and ferrule alignment. These functions are typically performed by individual or multiple components in any given connector system. Of course implementation of this embodiment would require a corresponding connector/transceiver to properly connect to the depicted connector 30.

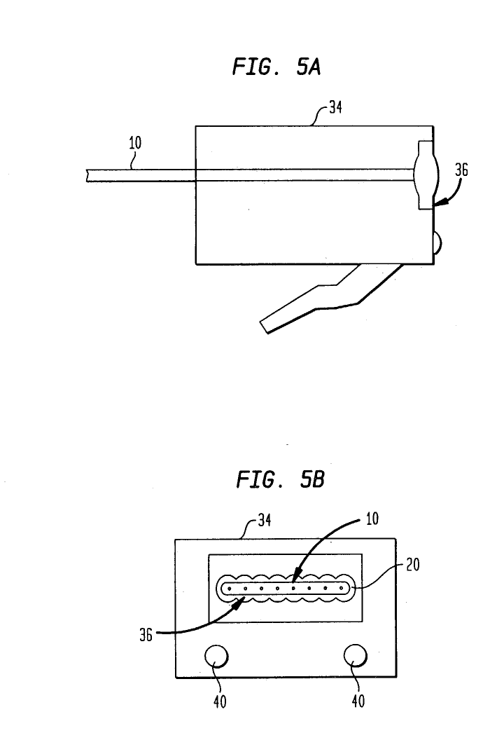

An additional embodiment of the invention is depicted in FIGS. 5A and 5B. In this embodiment the RJ11/RJ45 form factor connector 34 is molded from an optically transparent material and a focusing lens 36 is created in the front face of the connector. The slot or thru-hole 20 would guide the pre-cut fiber ribbon to the rear of the lens 36. Index matching gel, optical epoxy, or other adherent could be utilized in this embodiment.

An alternative embodiment is envisioned where the focusing lens is a separate component on one or more elements. In this embodiment, the connector 34 need not be molded from a transparent material.

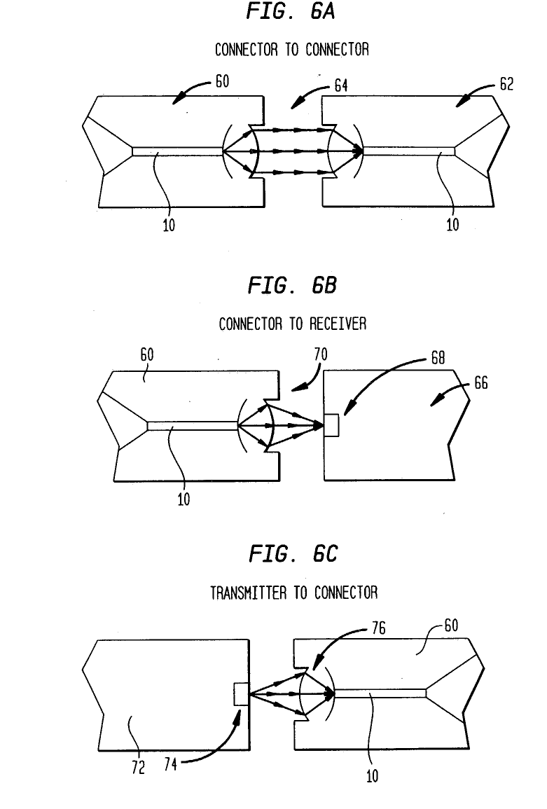

Lenses, in the various embodiments discussed above, are employed to optimize the optic fiber signal in the resulting connection. Example of such lens optimizations are depicted in FIGS. 6A-6C. FIG. 6A illustrates a collimated beam path 64 in a connector 60 to connector 62 assembly. The resulting beam has an essentially constant diameter.

FIG. 6B illustrates a lens employed to generate a focused beam path 70 in a connector 60 to receiver 66 assembly wherein the receiver contains a detector 68.

FIG. 6C illustrates an assembly between a transmitter 72 containing a diode 74 and a connector 60 wherein a focused beam path 76 is employed in the connection.

It is to be understood that the foregoing disclosure taught and described herein is illustrative of the present invention. Modifications may readily be devised by those ordinarily skilled in the art without departing from the spirit or scope of the present invention.

We claim:

1. A fiber optic connector for use in terminating a fiber optic cable, said cable comprising one or more optic fibers and a buffer material, said connector comprising:
a single thru-hole; and,
a connection end;
wherein said optic fibers and at least some of said buffer material pass through said single thru-hole and terminate at said connection end.

2. The fiber optic connector according to claim 1 wherein said cable is a ribbon cable and comprises two or more conductors.

3. The fiber optic connector according to claim 2 wherein said cable comprises a fiber ribbon array configuration of N rows by M columns where N×M>1.

4. The fiber optic connector according to claim 3 wherein said cable comprises buffer material positioned between said two or more conductors.

5. The fiber optic connector according to claim 4 further comprising one or more alignment pins.

6. The fiber optic connector according to claim 5 configured for use as a replacement for an MT ferrule MPO termination connector to thereby permit coupling with another device.

7. The fiber optic connector according to claim 6 further comprising a ferrule, said ferrule having a longitudinal axis and wherein said thru hole is located along said longitudinal axis.

8. The fiber optic connector according to claim 7 further comprising a keying mechanism to prevent coupling of said connector with an incompatible device.

9. The fiber optic connector according to claim 5 configured for use as a RJ11/RJ45 form factor connector.

10. The fiber optic connector according to claim 9 wherein said thru-hole is molded directly into the body of the connector.

11. The fiber optic connector according to claim 5 further comprising a lens.

12. The fiber optic connector according to claim 11 wherein said lens is integrally formed.

13. The fiber optic connector according to claim 11 wherein said lens is a separate component.

14. The fiber optic connector according to claim 111 wherein said lens is optimized for coupling to a transceiver.

15. The fiber optic connector according to claim 11 wherein said lens is optimized for coupling to another connector.

16. A method of producing an optical fiber connector for use in terminating a fiber optic ribbon cable having two or more optic fibers and a buffer material, said method comprising:
providing said connector with a single thru-hole; and
passing said optic ribbon cable and at least some of said buffer material through said thru-hole.
